(19) United States
(12) Patent Application Publication
(10) Pub. No.: US 2013/0091850 A1
(43) Pub. Date: Apr. 18, 2013

(54) METHOD AND SYSTEM FOR REDUCING HOT SOAKBACK

(71) Applicant: Jay M. Francisco, Chula Vista, CA (US)

(72) Inventor: Jay M. Francisco, Chula Vista, CA (US)

(73) Assignee: HAMILTON SUNDSTRAND CORPORATION, Windsor Locks, CT (US)

(21) Appl. No.: 13/272,581

(22) Filed: Oct. 13, 2011

(51) Int. Cl. F02C 7/12; F02C 9/00

(52) U.S. Cl. 60/772; 60/39.83

(57) ABSTRACT

A method for cooling a gas turbine engine includes supplying power to a motor to generate mechanical motion and translating the mechanical motion of the motor to a shaft of the gas turbine engine to rotate a compressor stage and a turbine stage after the engine has been shutdown to circulate air within the engine and cool engine components. A system for preventing hot soakback in an auxiliary power unit includes a starter motor, a compressor, a turbine, a shaft connected to at least one stage of the compressor and at least one stage of the turbine, a gearbox for connecting the starter motor to the shaft, a temperature sensor and a controller. The controller receives information from the temperature sensor and instructs the starter motor to rotate and drive the shaft when the temperature sensor senses a temperature above a low limit temperature threshold.

### BACKGROUND

Auxiliary power units (APUs) provide energy on aircraft for functions other than propulsion. APUs often operate when the aircraft is on the ground while the aircraft's main engine or engines are powered off. APUs can provide power to start the main engines or provide power to other aircraft accessories, such as the cabin air circulation system or pre-flight check systems. After an APU is powered off, components in the “hot” section of the APU (typically, the combustor, turbine and exhaust silencer) remain at elevated temperatures. The hot components increase the temperature of adjoining and nearby components through conductive and convective heating. This event is often referred to as “hot soakback”. During flight, the APU can be cooled with ram air. On the ground, however, ram air is not available for cooling the APU and hot soakback must be addressed with other cooling solutions.

Hot soakback can cause a number of problems in an APU. First, fuel in the nozzles of the combustor and fuel lines can increase in temperature, causing the fuel to coke within the nozzles and lines and thereby interfere with proper combustion the next time the APU is operated. The coked fuel can also cause seals in the APU to fail prematurely. To remedy this situation, some APUs utilize fuel purge systems to purge fuel from the nozzles and lines during APU shutdown. Second, some APU aircraft compartments utilize composite materials on the outer skin to reduce the overall weight of the aircraft. Typically, these composite materials are unable to withstand the high temperatures experienced in the “hot” section of the APU. As a result, significant amounts of insulation are needed to insulate the hot section of the APU from components containing composite materials and reduce hot soakback—more than what is needed for merely operating the APU. Additionally, certain components in the hot section of the APU remain at elevated temperatures longer due to the presence of other hot components located nearby. For example, the rear bearing of the turbine is particularly susceptible. The rear bearing soaks heat from other turbine components and exhaust silencer. Prolonged thermal stress can cause this bearing to fail prematurely.

While fuel purge systems and insulation can reduce some of the hot soakback effects, each of these solutions adds weight to the aircraft and increases production costs.

### SUMMARY

A method for cooling a gas turbine engine includes supplying power to a motor to generate mechanical motion and translating the mechanical motion of the motor to a shaft of the gas turbine engine to rotate a compressor stage and a turbine stage after the gas turbine engine has been shutdown to circulate air within the engine and cool engine components.

A method for cooling an auxiliary power unit includes discontinuing fuel delivery to a combustor of the auxiliary power unit, supplying power to a starter to rotate a starter shaft and translating rotational motion of the starter shaft to a shaft of the auxiliary power unit to rotate a compressor stage and a turbine stage of the auxiliary power unit to circulate air within the auxiliary power unit until a temperature of the auxiliary power unit is below a low limit temperature threshold.

A system for preventing hot soakback in an auxiliary power unit includes a starter motor, a compressor having at least one stage, a turbine having at least one stage, a shaft connected to the at least one stage of the compressor and the at least one stage of the turbine, a gearbox for connecting the starter motor to the shaft, a temperature sensor and a controller. The controller receives information from the temperature sensor, instructs the starter motor to rotate when the temperature sensor senses a temperature above about a low limit temperature threshold. The gearbox translates rotation of the starter motor to the shaft to rotate the at least one stage of the compressor and the at least one stage of the turbine to circulate air within the auxiliary power unit in response to the controller when the temperature sensor senses the temperature above the low limit temperature threshold in order to reduce hot soakback.

### BRIEF DESCRIPTION OF THE DRAWINGS

FIG. 1 illustrates a simplified schematic of an auxiliary power unit.

FIG. 2 illustrates a simplified flow diagram of a method for cooling an auxiliary power unit and reducing hot soakback.

FIG. 3 is a flow diagram illustrating the logic of one embodiment of the method illustrated in FIG. 2.

FIG. 4 is a flow diagram illustrating the logic of another embodiment of the method illustrated in FIG. 2.

### DETAILED DESCRIPTION

The present invention provides a method and system for reducing hot soakback within an auxiliary power unit (APU). According to the present invention, the shaft of the APU is rotated after shutdown to circulate air within the APU. According to one embodiment of the invention, the APU starter/generator is used to rotate the APU shaft. Stages of the APU compressor and turbine are rotated to circulate air within the APU. This air circulation reduces hot soakback by expelling hot air from the APU through the exhaust, allowing the circulated air to cool the “hot” components of the APU before it exits. In one embodiment of a system for reducing hot soakback, a starter controller controls the rotation of the starter/generator and the APU shaft depending on certain conditions within the APU.

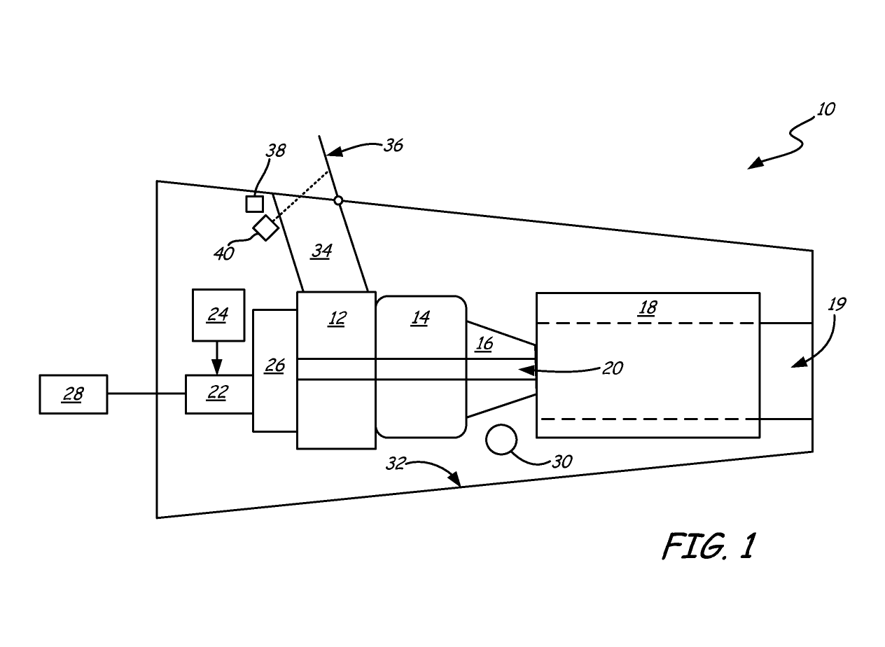

FIG. 1 illustrates one embodiment of an APU. APU 10 includes compressor 12, combustor 14, turbine 16, exhaust silencer 18 and exhaust pipe 19. Compressor 12 and turbine 16 are both connected to shaft 20. Fuel and air are mixed and ignited in combustor 14, increasing the temperature and pressure within combustor 14. The products of combustion (combustion gases) are forced into a turbine section where high velocity gas flow is directed over turbine blades to spin turbine 16. The rotation of turbine 16 provides power to compressor 12 via shaft 20. Compressor 12 provides high-pressure air for use in combustor 14. Energy can be extracted from APU 10 in the form of shaft rotation or compressed air, and this energy can then be used for various aircraft systems. Combustion gases exhaust APU 10 through exhaust pipe 19. As APUs are known in the art, a more detailed discussion of the basic operation of APU 10 will not be provided here.

APU 10 also includes starter/generator 22, starter controller 24 and gearbox 26. Starter 22 converts power into mechanical motion (e.g., rotation) that is used to initiate rotation of compressor 12 and turbine 16 to start the main engine section of APU 10 (compressor 12, combustor 14 and turbine 16). Starter 22 can be an electric starter motor or an air turbine starter. Gearbox 26 translates motion from starter 22 to shaft 20 to rotate shaft 20 and compressor 12 and turbine 16. Starter controller 24 provides operational instructions to starter 22. Starter controller 24 dictates whether starter 22 is running and at what speed starter 22 rotates.

Starter 22 receives power from power supply 28. In embodiments where starter 22 is an electric motor, power supply 28 is a battery, the main aircraft engines, terminal connection power or a ground cart. In one embodiment, power supply 28 is a direct current power source. In embodiments where starter 22 is an air turbine starter, power supply 28 provides a source of compressed air for rotating the flow turbine of starter 22. The compressed air can be delivered from a ground cart or be bled from the main aircraft engines.

APU 10 also includes temperature sensor 30. Temperature sensor 30 can measure the temperature of exhaust gases within APU 10 (e.g., an exhaust gas temperature sensor), the temperature of air within the APU but outside of the APU's gas flow path, or the temperature of a surface of APU 10 (e.g., a skin temperature sensor). In the embodiment illustrated in FIG. 1, temperature sensor 30 is within the interior of APU 10, but outside the gas flow path (inside compressor 12, combustor 14 and turbine 16). In embodiments were temperature sensor 30 is a skin temperature sensor, temperature sensor 30 can be positioned on inner surface 32 of APU 10 or on an APU component in the “cool” section of the APU (e.g., compressor 12, gearbox 26, etc.).

In some embodiments, APU 10 includes an inlet duct and a door for allowing air external to APU 10 to enter the inlet duct. As shown in FIG. 1, APU 10 includes inlet duct 34 and inlet door 36. Inlet duct 34 extends from compressor 12 to an exterior surface of APU 10. Inlet door 36 is present at the exterior surface to allow air from outside of APU 10 to enter inlet duct 34 when inlet door 36 is open. When inlet door 36 is open, external air can be drawn into compressor 12 via inlet duct 34 to provide compressor 12 with a source of ambient air. Door sensor 38 senses with inlet door 36 is in an open or closed position. Door actuator 40 moves inlet door 36 between the open and closed positions. In embodiments of APU 10 that do not include inlet door 36, air for compressor 12 is obtained from ambient outside air through a vent, air intake or other air inlet. In this embodiment door sensor 38 is not needed nor is the door circuit logic for starter controller 24.

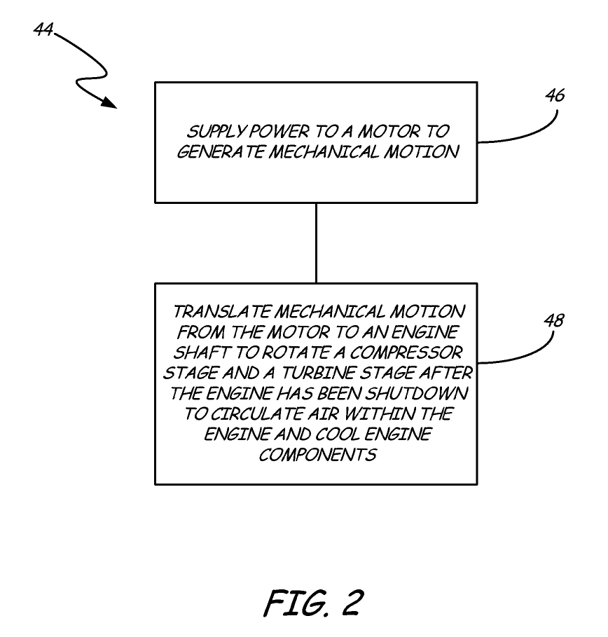

The operation of APU 10 to reduce hot soakback will now be described. FIG. 2 illustrates a simplified flow diagram of one embodiment of a method for cooling a gas turbine engine and reducing the effects of hot soakback. Method 44 includes supplying power to a motor (starter 22) to generate mechanical motion in step 46. Method 44 also includes translating the mechanical motion of the motor to a shaft (shaft 20) of the gas turbine engine (APU 10) in step 48. Step 48 is performed after the gas turbine engine has been shutdown. In step 48, rotating shaft 20 rotates a stage of compressor 12 and a stage of turbine 16 to circulate air within the engine. Circulating air within the gas turbine engine cools engine components. Hot air is expelled from the gas turbine engine through an exhaust (exhaust pipe 19).

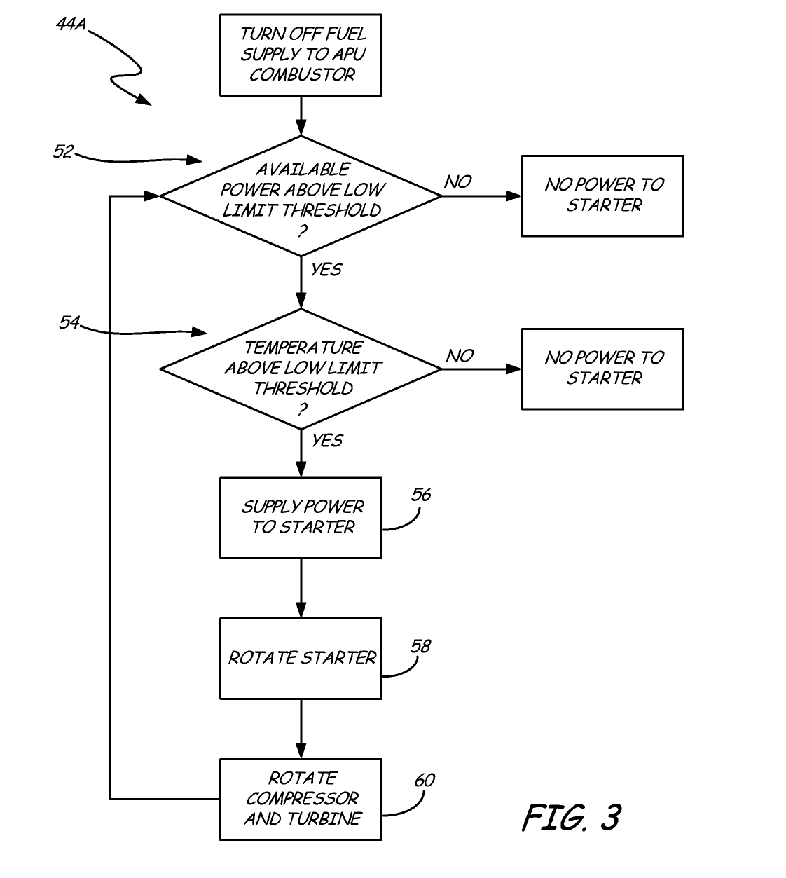

FIG. 3 is a flow diagram illustrating the logic involved in one embodiment of method 44 (denoted method 44A). Method 44A utilizes an electric starter and does not possess an inlet door and an inlet air duct for compressor 12. Method 44A begins once the fuel supply to combustor 14 is turned off. Once the fuel supply is cut off, combustor 14 stops burning fuel. Although combustor 14 no longer produces heat as a result of combustion once the supply of fuel ceases, combustor 14 (and turbine 16 and exhaust silencer 18) remains at an elevated temperature. In step 52, starter controller 24 determines whether sufficient power is available to carry out method 44A. Starter controller 24 receives information from power supply 28 concerning the amount of power available from power supply 28. If the amount of power available is below a low limit power threshold, power is not delivered to starter 22 or is discontinued. When the available power is below the low limit power threshold, method 44A does not proceed or is discontinued to conserve power when the power supply is limited (e.g., to conserve battery power for later engine starts). If adequate power is available, the process continues to step 54.

In step 54, starter controller 24 determines whether the temperature of APU 10 is above a low limit temperature threshold indicating that APU 10 must be cooled to prevent hot soakback effects. Starter controller 24 receives information from temperature sensor 30 concerning the temperature of APU exhaust gas or an air or surface temperature within APU 10. If the temperature sensed by temperature sensor 30 is below a low limit temperature threshold, the APU requires no additional cooling to prevent serious hot soakback effects and power is not delivered to starter 22 or is discontinued. If the temperature sensed by temperature sensor 30 is above a low limit temperature threshold, the process continues to step 56. In exemplary embodiments, the low limit temperature threshold is between about 177° C. (350° F.) and about 260° C. (500° F.), and more preferably between about 204° C. (400° F.) and about 232 ° C. (450 ° F.). In one particular embodiment, the low limit temperature threshold is about 204° C. (400° F.).

In step 56, starter controller 24 delivers power (e.g., electric or pneumatic power) from power supply 28 to starter 22. In step 58, starter controller 24 instructs starter 22 to rotate. Starter controller 24 controls the speed at which starter 22 rotates. As starter 22 rotates, gearbox 26 transmits power from the rotation of starter 22 to shaft 20. In some embodiments, starter controller 24 can also control the rate at which power is converted from starter 22 to shaft 20 by gearbox 26. In step 60, gearbox 26 engages with shaft 20 to rotate shaft 20, thereby rotating at least one stage of compressor 12 and at least one stage of turbine 16 to circulate air within APU 10.

In one embodiment, the supply of fuel to combustor 14 is shut off during step 60, to prevent further combustion (and heat formation) within APU 10. Once the supply of fuel to combustor 14 has been discontinued, shaft 20 can rotate at virtually any speed to circulate air within APU 10. In exemplary embodiments, shaft 20 rotates at a speed between about 25% and about 50% of nominal operation speed. In an alternate embodiment, shaft 20 is rotated below the light-off speed of APU 10 during step 60. The light-off speed is the rotation speed at which APU 10 will begin burning fuel and can efficiently run on its own. Light-off speeds for APUs are typically between about 10% and about 40% of nominal operation speed. While FIG. 3 generally illustrates on/off logic resulting in a continuous mode of operation, it will be appreciated that method 44A can be modified to operate in a stepped mode of operation in which starter 22 and/or shaft 20 are rotated at slower speeds as the temperature sensed by temperature sensor 30 decreases.

By rotating at least one stage of compressor 12 and at least one stage of turbine 16 in step 60, air is circulated through APU 10 and eventually exits through exhaust pipe 19. The circulating air absorbs heat from the hot components within APU 10 (e.g., combustor 14 and turbine 16) and exits through exhaust pipe 19, thereby carrying high temperature air away from APU 10 to reduce or eliminate the effects of hot soakback within APU 10.

As indicated in FIG. 3, steps 56, 58 and 60 continue until power supply 28 is no longer able to supply sufficient power or the temperature of APU 10 is reduced below the low temperature threshold limit. In exemplary embodiments, the low temperature threshold limit is reached within about 10 minutes. In one particular embodiment, the low temperature threshold limit is reached within about 7 minutes. Factors determining the time until the low temperature threshold limit is reached include the initial temperature of combustor 14, turbine 16 and exhaust silencer 18; the velocity and mass flow of the air circulated during step 60; the temperature of the air delivered to compressor 12 and the external air temperature.

By balancing the amount of power delivered to starter 22 and the speed at which starter 22 rotates, starter controller 24 can provide adequate cooling of APU 10 while minimizing the amount of power drawn from power supply 28. For example, starter controller 24 can minimize power draw by rotating starter 22 at a lower speed for a slightly longer length of time when power supply 28 is a battery. When power is supplied by a terminal connection and power draw is a lesser concern, starter controller 24 can rotate starter 22 at a higher speed for a shorter length of time to cool APU 10 more quickly.

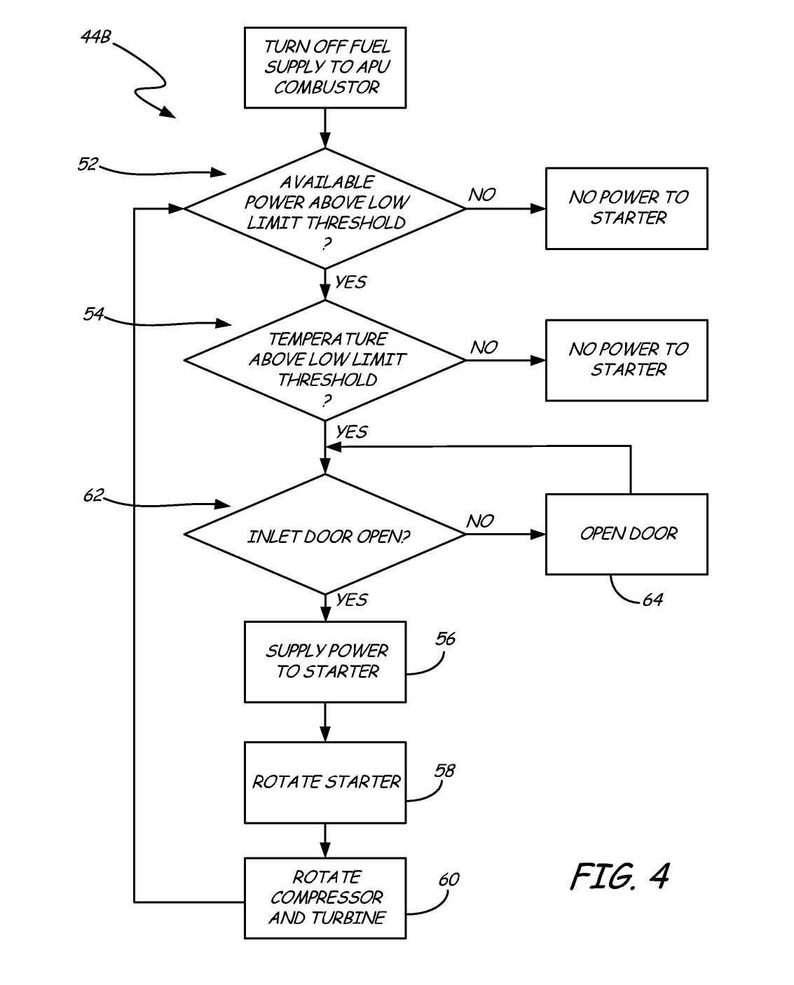

FIG. 4 is a flow diagram illustrating the logic involved in another embodiment of method 44 (denoted method 44B). Method 44B is similar to method 44A except that method 44B possesses an inlet door and an inlet air duct for compressor 12. Steps 52, 54, 56, 58 and 60 are the same in method 44B as described above with reference to method 44A. Additionally, starter controller 24 ensures that inlet door 36 is in an open position while compressor 12 is being rotated. In step 62, starter controller 24 receives information from door sensor 38 concerning the position of inlet door 36 (i.e. open or closed). If inlet door 36 is closed, starter controller 24 instructs door actuator 40 to open inlet door 36 in step 64 before power is supplied to starter 22 in step 56. If inlet door 36 is in the closed position and compressor 12 is rotating, inlet duct 34 can collapse due to the vacuum formed in inlet duct 34 by operation of compressor 12. Additionally, compressor 12 can surge if inlet door 36 is closed and insufficient air is delivered to compressor 12 through inlet duct 34. Thus, as shown in FIG. 4, starter controller 24 ensures that inlet door 36 is in an open position in order for power to be supplied to starter 22 to rotate shaft 20.

Method 44 provides a method and system for reducing hot soakback effects within APU 10. Other methods of reducing hot soakback come with disadvantages. Fuel purge systems used to purge fuel lines, fuel injectors and fuel nozzles add additional cost and weight to APU 10. Fuel purge systems also do not provide benefits to APU components besides the fuel system (e.g., they provide no benefit to composite components). Providing additional insulation within APU 10 also adds weight and cost. Additional insulation also does not provide significant benefits to the fuel system. By utilizing method 44, the effects of hot soakback can be reduced without adding significant weight or additional costs to APU 10. Method 44 utilizes existing components of APU 10 to provide a method for reducing hot soakback. Only minor changes and additions are necessary. Due to increased use during method 44, a more robust starter/generator 22 than one used only to start APU 10 may be warranted. The addition of starter controller 24 adds some cost and weight, but pales in comparison to a fuel purge system and additional insulation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method for cooling a gas turbine engine, the method comprising:
supplying power to a motor to generate mechanical motion; and
translating the mechanical motion of the motor to a shaft of the gas turbine engine to rotate a compressor stage and a turbine stage after the gas turbine engine has been shutdown to circulate air within the gas turbine engine and cool components of the gas turbine engine.

2. The method of claim 1, wherein the gas turbine engine is an auxiliary power unit, and wherein the motor is a starter motor.

3. The method of claim 1, wherein a gearbox translates the mechanical motion of the motor to the gas turbine engine shaft.

4. The method of claim 1, wherein the compressor and turbine stages are rotated until a temperature of an engine exhaust gas is less than a low limit temperature threshold.

5. The method of claim 4, wherein the low limit temperature threshold is between about 204° C. (400° F.) and about 232° C. (450° F.).

6. The method of claim 1, wherein the compressor and turbine stages are rotated until a temperature of an engine surface is less than a low limit temperature threshold.

7. The method of claim 6, wherein the low limit temperature threshold is between about 204° C. (400° F.) and about 232° C. (450° F.).

8. The method of claim 1, further comprising:
opening an inlet duct door before supplying power to the motor to allow air external to the engine to flow into the compressor stage; and
maintaining the inlet duct door in an open position while the compressor stage is rotating.

9. The method of claim 1, wherein a controller receives information from a temperature sensor to determine whether to supply power to the motor.

10. The method of claim 9, wherein the temperature sensor measures temperature of engine exhaust gas.

11. The method of claim 9, wherein the temperature sensor measures temperature of an engine surface.

12. The method of claim 9, wherein the controller receives information from a door sensor to determine whether to supply power to the motor.

13. The method of claim 1, wherein the compressor and turbine stages are rotated below an engine light-off speed.

14. The method of claim 1, wherein the compressor and turbine stages are rotated while the gas turbine engine receives no fuel.

15. The method of claim 1, wherein the compressor and turbine stages are rotated for a time less than about 10 minutes.

16. The method of claim 1, wherein power is supplied to the motor only when a voltage limit of a power supply is above a low limit power threshold.

17. A method for cooling an auxiliary power unit, the method comprising:
discontinuing fuel delivery to a combustor of the auxiliary power unit;
supplying power to a starter to rotate a starter shaft; and
translating rotational motion of the starter shaft to a shaft of the auxiliary power unit to rotate a compressor stage and a turbine stage of the auxiliary power unit to circulate air within the auxiliary power unit until a temperature of the auxiliary power unit is below a low limit temperature threshold.

18. The method of claim 17, wherein the low limit temperature threshold is between about 204° C. (400° F.) and about 232° C. (450° F.).

19. A system for preventing hot soakback in an auxiliary power unit, the system comprising:
a starter motor;
a compressor having at least one stage;
a turbine having at least one stage;
a shaft connected to the at least one stage of the compressor and the at least one stage of the turbine;
a gearbox for connecting the starter motor to the shaft;
a temperature sensor; and
a controller for:
receiving information from the temperature sensor; and
instructing the starter motor to rotate when the temperature sensor senses a temperature above a low limit temperature threshold;
wherein the gearbox translates rotation of the starter motor to the shaft to rotate the at least one stage of the compressor and the at least one stage of the turbine to circulate air within the auxiliary power unit in response to the controller when the temperature sensor senses the temperature above the low limit temperature threshold in order to reduce hot soakback.

20. The system of claim 19, further comprising:
an inlet duct in communication with the compressor;
an inlet door for allowing air external to the auxiliary power unit to the inlet duct when the inlet door is in an open position; and
a door sensor for determining whether the inlet door is in an open position, wherein the controller receives information from the door sensor and instructs the starter motor to operate only when the inlet door is in an open position.
